(19) United States
(12) Patent Application Publication
(10) Pub. No.: US 2003/0203336 A1
(43) Pub. Date: Oct. 30, 2003

(54) Dental suction arm stand

(76) Inventor: Elizabeth Somodi, Toronto (CA)

Correspondence Address: ELIAS C. BORGES, 1 EVA ROAD, SUITE 406, TORONTO, ON, M9C 4Z5, CA

(21) Appl. No.: 10/140,835

(22) Filed: Apr. 25, 2002

(51) Int. Cl. A61C 17/06; A61C 13/38

(52) U.S. Cl. 433/91; 433/96; 433/77

(57) ABSTRACT

The invention is a self supporting oral evacuation hose consisting of a post, a base for supporting the post in a substantially vertical orientation, a flexible evacuation hose, an evacuation tip operatively coupled to one end of the hose, a hose coupling connector located on the other end of the hose, and an arm having a distal end. The arm is secured to the post and the evacuation tip is positioned on the distal end of the arm. The arm is adapted to selectively position the evacuation tip relative to the post. The arm may be hollow to permit a portion of the hose to be contained in the hollow of the arm. The arm is preferably articulated in the manner of a goose neck and bendable such that the distal end can be positioned as desired. A valve may be positioned at the distal end to control the evacuation tip. A platform may also be mounted to the post to act as a stand for x-ray print outs or the like.

### FIELD OF THE INVENTION

The invention relates to evacuation hoses for evacuating spray and debris from a patient's mouth during dental procedures.

### BACKGROUND OF THE INVENTION

High velocity evacuation devices are commonly used during dental treatment. The high velocity evacuation devices commonly used in dental offices generally consist of an elongated flexible house having opposite ends, a vacuum pump operatively coupled to one end of the hose and having an evacuation tip located at the other end of the hose. The vacuum pump is adapted to draw a large volume of air through the hose in order to draw up debris and spray through the evacuation tip. To operate the high velocity evacuation system, the evacuation tip must be held in the patient's mouth. With the evacuation tip properly positioned, spray generated by dental drills, ultrasonic scalers or other powered dental equipment may be drawn into the evacuation tip and away from the both the patient's and the dental practitioner's face. The evacuation tip is generally provided with a comfortable grip to permit the tip to be comfortably held. Regardless of how comfortable the grip may be, however, the doctor or dental hygienist will generally require an assistant to hold and position the evacuation tip in the correct orientation. When an assistant is not available, then the high volume suction is not used.

### SUMMARY OF THE INVENTION

In accordance with one aspect of the present invention, an evacuation hose is which is self supporting and easy to use is disclosed. The self supporting evacuation hose consists of a post and base combination adapted to support the post in a substantially vertical orientation. A flexible high velocity hose having opposite first and second ends is supported by the post. An evacuation tip is positioned on the first end of the evacuation hose and a hose coupling connector is positioned the second end of the evacuation hose. The post is provided with an arm having a distal end, the evacuation tip being positioned on the distal end of the arm. The arm is adapted to selectively position the evacuation tip relative to the rest of the post.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a perspective view of the invention.

FIG. 2. is a perspective view of the invention being used on a patient In the drawings like characters of reference indicate corresponding parts in the different figures.

### DETAILED DESCRIPTION OF THE INVENTION

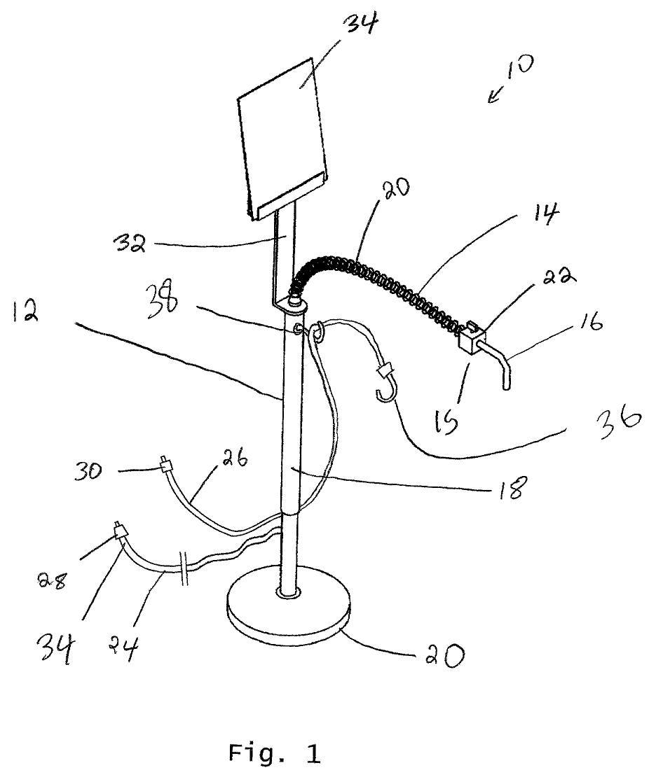

Referring firstly to FIG. 1, the evacuation hose of the present invention, shown generally as item 10, consists of a flexible arm 14 mounted onto stand 12. Arm 14 has a distal end 15 which carries an evacuator tip 16. Stand 12 consists of an elongated hollow post 18 rigidly mounted onto a base 20. Post 18 is hollow and is dimensioned to carry flexible hose 24. Flexible arm 14 consists of a flexible goose neck 20 mounted to post 12. Goose neck 20 is also hollow and is dimensioned to permit flexible hose 24 to pass through inside the goose neck.

Flexible hose 24 has coupling 28 located on end 34 of the hose. Coupling 28 is adapted to couple to a standard high velocity dental suction unit (not shown). Hose 24 passes through post 18 and goose neck 20 to distal end 15, where it is coupled to valve 22 and evacuation tip 16. Evacuation tip 16 is substantially similar to other standard evacuation tips used in dental suction devices and is adapted to draw in spray and debris generated during dental surgery. Valve 22 controls flow of suction through tip 16.

Gooseneck 20 is sufficiently flexible to be bent into a variety of different shapes simply by bending it as desired. Gooseneck 20 is also sufficiently resilient enough to hold its shape after it has been bent into the desired shape. Evacuation tip 16 may be precisely positioned adjacent a patient's mouth (not shown) simply by bending gooseneck 20 appropriately. After gooseneck 20 is properly bent to position tip 16 as needed, the doctor may then proceed with the dental surgery.

To increase the utility of evacuation hose stand 10, post 12 may be provided with a hanging hook 38. Hook 38 can be used to support saliva ejector hose 26. Saliva ejector hose 26 has a coupling 30 on one end and a saliva ejector 36 on the other. When saliva ejector 36 is placed in a patient's mouth (not shown) and coupling 30 is attached to a dental vacuum device (not shown), hook 38 can support hose 26 so that it does not become entangled.

Platform stand 34 is attached to post 18 via support arm 32. Platform stand 34 is adapted to hold x-ray photos or other material which may be required by the medical professional performing the dental operation.

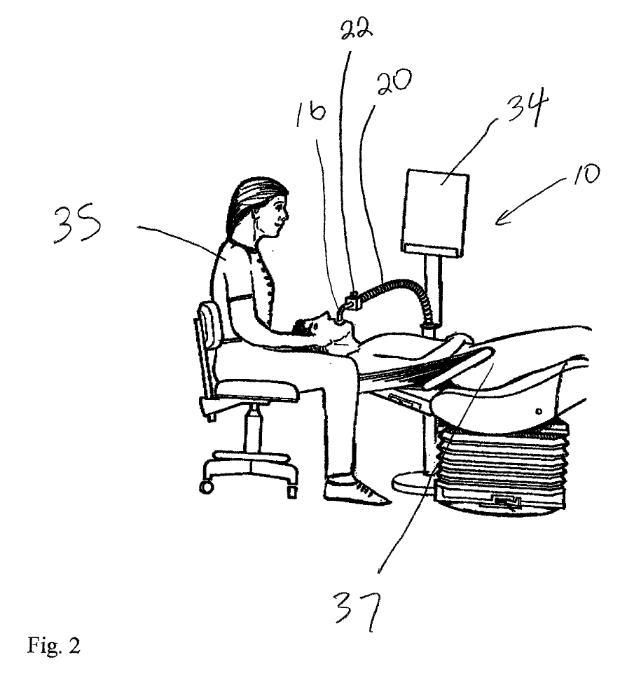

Referring now to FIG. 2, dental hygienist 35 can use device 10 to assist in performing dental procedures on patient 37. The dental hygienist positions evacuator tip 16 in patient 37's mouth by bending goose neck 20 into an appropriate position. The dental hygienist can then engage valve 22 to activate the high velocity suction to permit any spray or debris from flying into either the hygienist's face or the face of the patient. Any x-rays or other documents that the hygienist may wish to consult during the dental procedure can be placed onto platform 34 which can be easily viewed by the hygienist. With platform 34 properly oriented towards the hygienist and evacuator tip 16 properly positioned, the hygienist will have full use of both her hands to perform the dental procedure.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A self supporting oral evacuation hose comprising:
a) a post;
b) a base for supporting the post in a substantially vertical orientation,
c) a flexible high velocity hose having opposite first and second ends;
d) an evacuation tip operatively coupled to the first end of the evacuation hose;
e) a hose coupling connector operatively coupled to the second end of the evacuation hose;
f) an arm having a distal end, the arm being secured to the post, the evacuation tip being positioned on the distal end of the arm, and
g) the arm being adapted to selectively position the evacuation tip relative to the post.

2. A self supporting oral evacuation hose as defined in claim 1 wherein the arm is hollow and wherein a portion of the hose is contained in the arm.

3. A self supporting oral evacuation hose as defined in claim 1 wherein the arm is selectively bendable.

4. A self supporting oral evacuation hose as defined in claim 1 wherein the arm is articulated.

5. A self supporting oral evacuation hose as defined in claim 1 wherein the arm comprises a goose neck.

6. A self supporting oral evacuation hose as defined in claim 1 further comprising a vacuum control valve located adjacent the evacuator tip.

7. A self supporting oral evacuation hose as defined in claim 1 further comprising a platform stand mounted to the post.
